(19) United States
(12) Patent Application Publication
(10) Pub. No.: US 2013/0265240 A1
(43) Pub. Date: Oct. 10, 2013

(54) METHOD AND APPARATUS FOR PRESENTING A VIRTUAL TOUCHSCREEN

(71) Applicant: Lee G. Friedman, Alpharetta, GA (US)

(72) Inventor: Lee G. Friedman, Alpharetta, GA (US)

(73) Assignee: AT&T Intellectual Property I, LP, Atlanta, GA (US)

(21) Appl. No.: 13/441,072

(22) Filed: Apr. 6, 2012

(51) Int. Cl. G06F 3/041

(52) U.S. Cl. 345/173

(57) ABSTRACT

A system that incorporates teachings of the subject disclosure may include, for example, a method for generating a virtual touchscreen according to a first relative position between a plurality of member parts of a user and according to a second relative position of at least one member part of the user and a body surface of the user, tracking a location of the user, and positioning the virtual touchscreen according to the location of the user. Other embodiments are disclosed.

### FIELD OF THE DISCLOSURE

The subject disclosure relates generally to a method and apparatus for presenting a virtual touchscreen.

### BACKGROUND

Certain multimedia presentation products such as gaming consoles or television receivers provide gesture detection features, which can be utilized for controlling aspects of a game or functions of a television. Some of these systems employ inverse kinematics to profile a user and to detect gestures movements according to data associated with the profile. Detected gestures can be used for controlling, for example, audible volume of a television, or movements of an avatar in a video game.

### BRIEF DESCRIPTION OF THE DRAWINGS

Reference will now be made to the accompanying drawings, which are not necessarily drawn to scale, and wherein:

FIGS. 1-2 depict illustrative embodiments of communication systems that provide media services;

FIG. 3 depicts an illustrative embodiment of a web portal for interacting with the communication systems of FIGS. 1-2;

FIG. 4 depicts an illustrative embodiment of a communication device utilized in the communication systems of FIGS. 1-2;

FIGS. 5-6 depict illustrative embodiments of a system for generating a virtual touchscreen;

FIGS. 7-11 depict illustrative embodiments for calibrating the virtual touchscreen;

FIGS. 12-18 depict illustrative embodiments for controlling the virtual touchscreen;

FIGS. 19-20 depict illustrative embodiments of methods operating in portions of the systems described in FIGS. 1-6; and

FIG. 21 is a diagrammatic representation of a machine in the form of a computer system within which a set of instructions, when executed, may cause the machine to perform any one or more of the methods described herein.

### DETAILED DESCRIPTION

The subject disclosure describes, among other things, illustrative embodiments for calibrating and controlling a virtual touchscreen. Other embodiments are contemplated by the subject disclosure.

One embodiment of the subject disclosure includes a device having a memory storing computer instructions, and a processor coupled to the memory. Responsive to executing the computer instructions, the processor can perform operations presenting a virtual touchscreen at a presentation device, receiving from a sensor a plurality of signals comprising image information and depth information associated with member parts of a user, generating first calibration data from the plurality of signals to identify a plurality of dimensions of the virtual touchscreen, and generating second calibration data from the plurality of signals to identify an operating distance between the user and the virtual touchscreen.

One embodiment of the subject disclosure includes a computer-readable storage medium having computer instructions, which when executed by at least one processor causes the at least one processor to perform operations including generating first calibration data from a plurality of signals to identify a plurality of dimensions of a virtual touchscreen, generating second calibration data from the plurality of signals to identify an operating distance between the user and the virtual touchscreen, generating an updated virtual touchscreen according to the first and second calibration data, tracking a location of the user, and positioning the updated virtual touchscreen according to the location of the user.

One embodiment of the subject disclosure includes a method for generating, by a system having at least one processor, a virtual touchscreen according to a first relative position between a plurality of member parts of a user, and according to a second relative position of at least one member part of the user and a body surface of the user, tracking, by the system, a location of the user, and positioning, by the system, the virtual touchscreen according to the location of the user.

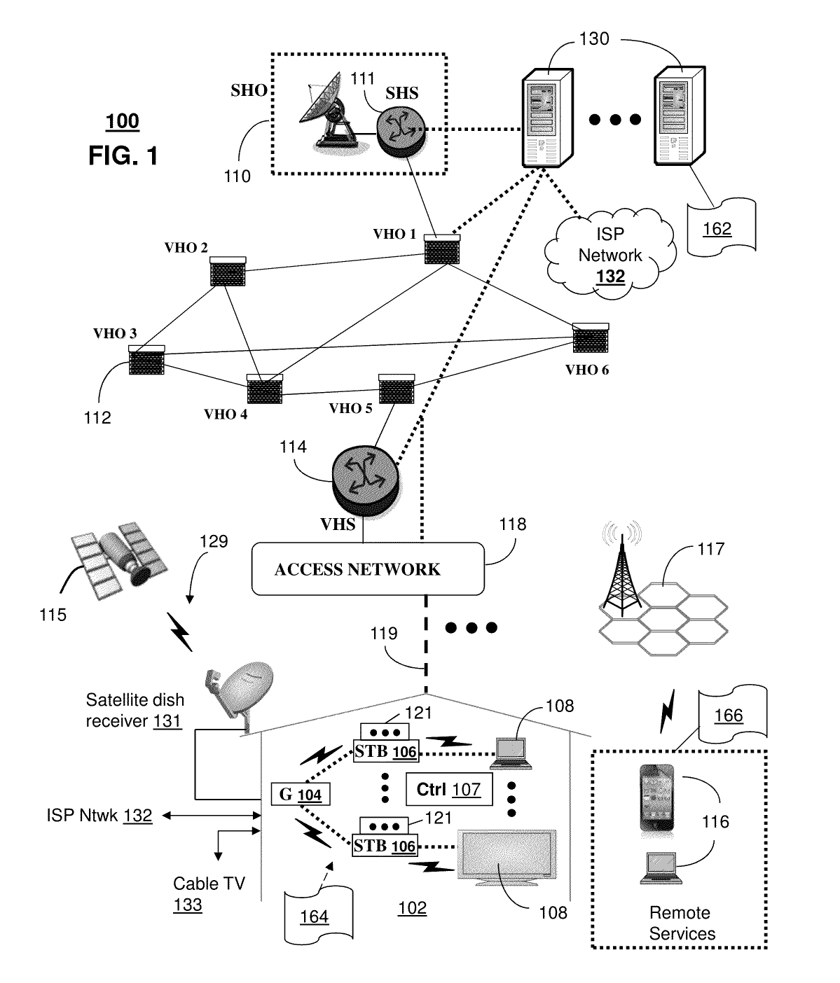

FIG. 1 depicts an illustrative embodiment of a first communication system 100 for delivering media content. The communication system 100 can represent an Internet Protocol Television (IPTV) media system. The IPTV media system can include a super head-end office (SHO) 110 with at least one super headend office server (SHS) 111 which receives media content from satellite and/or terrestrial communication systems. In the present context, media content can represent, for example, audio content, moving image content such as 2D or 3D videos, video games, virtual reality content, still image content, and combinations thereof. The SHS server 111 can forward packets associated with the media content to one or more video head-end servers (VHS) 114 via a network of video head-end offices (VHO) 112 according to a multicast communication protocol.

The VHS 114 can distribute multimedia broadcast content via an access network 118 to commercial and/or residential buildings 102 housing a gateway 104 (such as a residential or commercial gateway). The access network 118 can represent a group of digital subscriber line access multiplexers (DSLAMs) located in a central office or a service area interface that provide broadband services over fiber optical links or copper twisted pairs 119 to buildings 102. The gateway 104 can use communication technology to distribute broadcast signals to media processors 106 such as Set-Top Boxes (STBs) which in turn present broadcast channels to media devices 108 such as computers or television sets managed in some instances by a media controller 107 (such as an infrared or RF remote controller).

The gateway 104, the media processors 106, and media devices 108 can utilize tethered communication technologies (such as coaxial, powerline or phone line wiring) or can operate over a wireless access protocol such as Wireless Fidelity (WiFi), Bluetooth, Zigbee, or other present or next generation local or personal area wireless network technologies. By way of these interfaces, unicast communications can also be invoked between the media processors 106 and subsystems of the IPTV media system for services such as video-on-demand (VoD), browsing an electronic programming guide (EPG), or other infrastructure services.

A satellite broadcast television system 129 can be used in the media system of FIG. 1. The satellite broadcast television system can be overlaid, operably coupled with, or replace the IPTV system as another representative embodiment of communication system 100. In this embodiment, signals transmitted by a satellite 115 that include media content can be received by a satellite dish receiver 131 coupled to the building 102. Modulated signals received by the satellite dish receiver 131 can be transferred to the media processors 106 for demodulating, decoding, encoding, and/or distributing broadcast channels to the media devices 108. The media processors 106 can be equipped with a broadband port to an Internet Service Provider (ISP) network 132 to enable interactive services such as VoD and EPG as described above.

In yet another embodiment, an analog or digital cable broadcast distribution system such as cable TV system 133 can be overlaid, operably coupled with, or replace the IPTV system and/or the satellite TV system as another representative embodiment of communication system 100. In this embodiment, the cable TV system 133 can also provide Internet, telephony, and interactive media services.

It is contemplated that the subject disclosure can apply to other present or next generation over-the-air and/or landline media content services system.

Some of the network elements of the IPTV media system can be coupled to one or more computing devices 130, a portion of which can operate as a web server for providing web portal services over the ISP network 132 to wireline media devices 108 or wireless communication devices 116.

Each media processor 106 of FIG. 1 can be further equipped with a sensor 121 that enables the media processors 106 to detect a user's image, depth of body parts of the user, body motions, or other biometric features of the user, which can be used to a virtual touchscreen enabling the user to control media presented by the media processor 106 according to software function 164. The wireless configuration devices 116 can also include a sensor similar in functionality to sensor 121 and configured with software function 162 to perform virtual touchscreen processing as described for the media processor 106.

Communication system 100 can also provide for all or a portion of the computing devices 130 to function as a server (herein referred to as server 130). The server 130 can use computing and communication technology to perform function 162, which can perform among things, processing of biometric information captured by sensors 121, and enabling or configuring control of media presentations provided by the media processor 106. The media processors 106 and wireless communication devices 116 can be provisioned with software functions 162 and 164, respectively, to utilize the services of server 130.

It is further contemplated that multiple forms of media services can be offered to media devices over landline technologies such as those described above. Additionally, media services can be offered to media devices by way of a wireless access base station 117 operating according to common wireless access protocols such as Global System for Mobile or GSM, Code Division Multiple Access or CDMA, Time Division Multiple Access or TDMA, Universal Mobile Telecommunications or UMTS, World interoperability for Microwave or WiMAX, Software Defined Radio or SDR, Long Term Evolution or LTE, and so on. Other present and next generation wide area wireless access network technologies are contemplated by the subject disclosure.

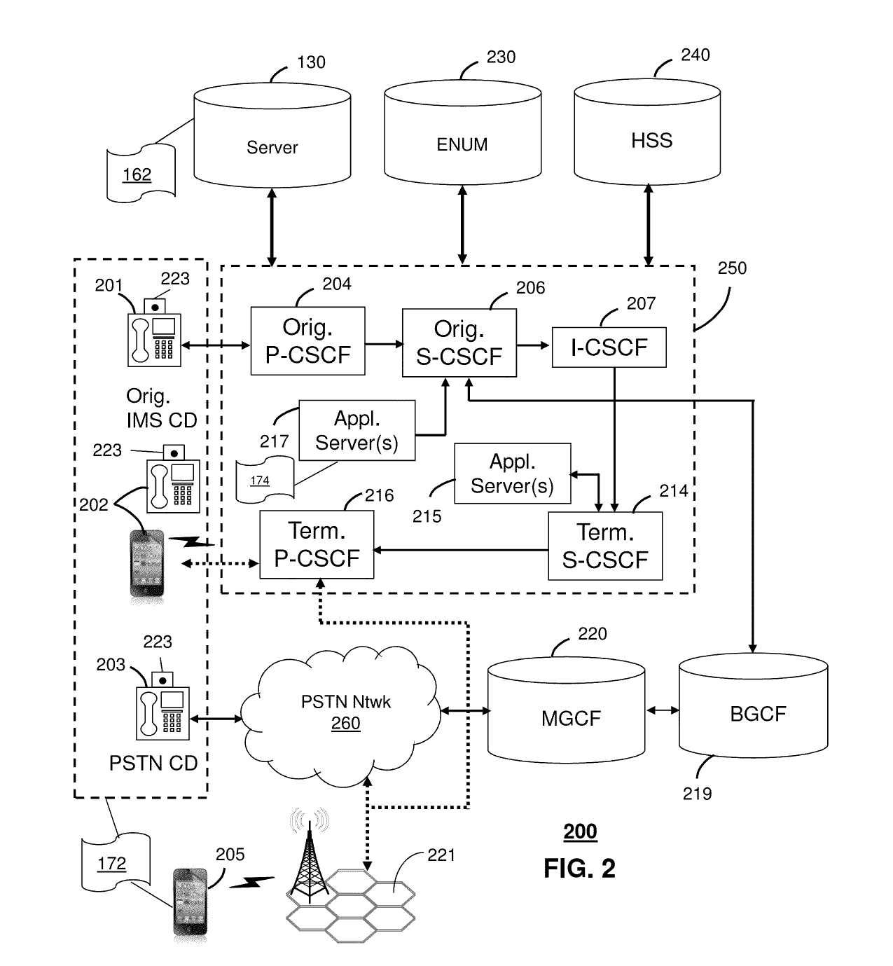

FIG. 2 depicts an illustrative embodiment of a communication system 200 employing an IP Multimedia Subsystem (IMS) network architecture to facilitate the combined services of circuit-switched and packet-switched systems. Communication system 200 can be overlaid or operably coupled with communication system 100 as another representative embodiment of communication system 100.

Communication system 200 can comprise a Home Subscriber Server (HSS) 240, a tElephone NUmber Mapping (ENUM) server 230, and other network elements of an IMS network 250. The IMS network 250 can establish communications between IMS-compliant communication devices (CDs) 201, 202, Public Switched Telephone Network (PSTN) CDs 203, 205, and combinations thereof by way of a Media Gateway Control Function (MGCF) 220 coupled to a PSTN network 260. The MGCF 220 need not be used when a communication session involves IMS CD to IMS CD communications. A communication session involving at least one PSTN CD may utilize the MGCF 220.

IMS CDs 201, 202 can register with the IMS network 250 by contacting a Proxy Call Session Control Function (P-CSCF) which communicates with an interrogating CSCF (I-CSCF), which in turn, communicates with a Serving CSCF (S-CSCF) to register the CDs with the HSS 240. To initiate a communication session between CDs, an originating IMS CD 201 can submit a Session Initiation Protocol (SIP INVITE) message to an originating P-CSCF 204 which communicates with a corresponding originating S-CSCF 206. The originating S-CSCF 206 can submit the SIP INVITE message to one or more application servers (ASs) 217 that can provide a variety of services to IMS subscribers.

For example, the application servers 217 can be used to perform originating call feature treatment functions on the calling party number received by the originating S-CSCF 206 in the SIP INVITE message. Originating treatment functions can include determining whether the calling party number has international calling services, call ID blocking, calling name blocking, 7-digit dialing, and/or is requesting special telephony features (e.g., *72 forward calls, *73 cancel call forwarding, *67 for caller ID blocking, and so on). Based on initial filter criteria (iFCs) in a subscriber profile associated with a CD, one or more application servers may be invoked to provide various call originating feature services.

Additionally, the originating S-CSCF 206 can submit queries to the ENUM system 230 to translate an E.164 telephone number in the SIP INVITE message to a SIP Uniform Resource Identifier (URI) if the terminating communication device is IMS-compliant. The SIP URI can be used by an Interrogating CSCF (I-CSCF) 207 to submit a query to the HSS 240 to identify a terminating S-CSCF 214 associated with a terminating IMS CD such as reference 202. Once identified, the I-CSCF 207 can submit the SIP INVITE message to the terminating S-CSCF 214. The terminating S-CSCF 214 can then identify a terminating P-CSCF 216 associated with the terminating CD 202. The P-CSCF 216 may then signal the CD 202 to establish Voice over Internet Protocol (VoIP) communication services, thereby enabling the calling and called parties to engage in voice and/or data communications. Based on the iFCs in the subscriber profile, one or more application servers may be invoked to provide various call terminating feature services, such as call forwarding, do not disturb, music tones, simultaneous ringing, sequential ringing, etc.

In some instances the aforementioned communication process is symmetrical. Accordingly, the terms “originating” and “terminating” in FIG. 2 may be interchangeable. It is further noted that communication system 200 can be adapted to support video conferencing. In addition, communication system 200 can be adapted to provide the IMS CDs 201, 202 with the multimedia and Internet services of communication system 100 of FIG. 1.

If the terminating communication device is instead a PSTN CD such as CD 203 or CD 205 (in instances where the cellular phone only supports circuit-switched voice communications), the ENUM system 230 can respond with an unsuccessful address resolution which can cause the originating S-CSCF 206 to forward the call to the MGCF 220 via a Breakout Gateway Control Function (BGCF) 219. The MGCF 220 can then initiate the call to the terminating PSTN CD over the PSTN network 260 to enable the calling and called parties to engage in voice and/or data communications.

It is further appreciated that the CDs of FIG. 2 can operate as wireline or wireless devices. For example, the CDs of FIG. 2 can be communicatively coupled to a cellular base station 221, a femtocell, a WiFi router, a Digital Enhanced Cordless Telecommunications (DECT) base unit, or another suitable wireless access unit to establish communications with the IMS network 250 of FIG. 2. The cellular access base station 221 can operate according to common wireless access protocols such as GSM, CDMA, TDMA, UMTS, WiMax, SDR, LTE, and so on. Other present and next generation wireless network technologies are contemplated by the subject disclosure. Accordingly, multiple wireline and wireless communication technologies are contemplated for the CDs of FIG. 2.

It is further contemplated that cellular phones supporting LTE can support packet-switched voice and packet-switched data communications and thus may operate as IMS-compliant mobile devices. In this embodiment, the cellular base station 221 may communicate directly with the IMS network 250 as shown by the arrow connecting the cellular base station 221 and the P-CSCF 216.

It is further understood that alternative forms of a CSCF can operate in a device, system, component, or other form of centralized or distributed hardware and/or software. Indeed, a respective CSCF may be embodied as a respective CSCF system having one or more computers or servers, either centralized or distributed, where each computer or server may be configured to perform or provide, in whole or in part, any method, step, or functionality described herein in accordance with a respective CSCF. Likewise, other functions, servers and computers described herein, including but not limited to, the HSS, the ENUM server, the BGCF, and the MGCF, can be embodied in a respective system having one or more computers or servers, either centralized or distributed, where each computer or server may be configured to perform or provide, in whole or in part, any method, step, or functionality described herein in accordance with a respective function, server, or computer.

The server 130 of FIG. 1 can be operably coupled to the second communication system 200 for purposes similar to those described above. It is further contemplated by the subject disclosure that server 130 can perform function 162 and thereby provide services to the CDs 201, 202, 203 and 205 of FIG. 2. CDs 201, 202, 203 and 205, which can be adapted with software to perform function 172 to utilize the services of the server 130. It is further contemplated that the server 130 can be an integral part of the application server(s) 217 performing function 174, which can be substantially similar to function 162 and adapted to the operations of the IMS network 250. It is also contemplated that CDs 201, 202, 203 and 205 can be equipped with a sensor 223 having similar functionality to the sensor 121 described in FIG. 1.

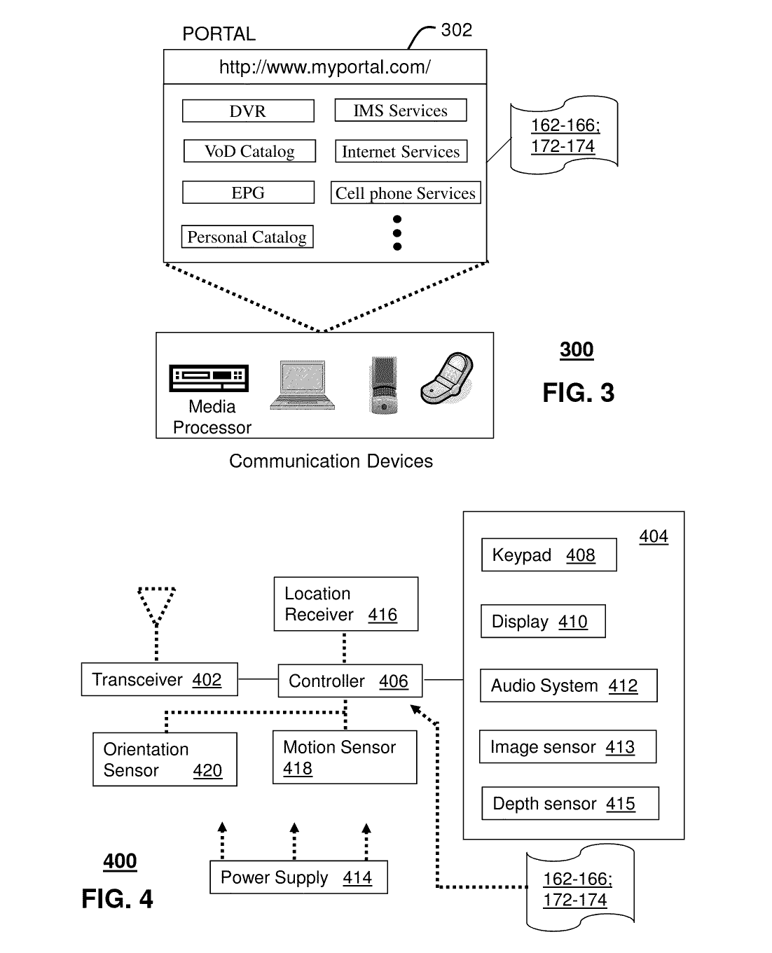

FIG. 3 depicts an illustrative embodiment of a web portal 302 which can be hosted by server applications operating from the computing devices 130 of the communication system 100 illustrated in FIG. 1. The web portal 302 can be used for managing services of communication systems 100-200. A web page of the web portal 302 can be accessed by a Uniform Resource Locator (URL) with an Internet browser such as Microsoft's Internet Explorer™, Mozilla's Firefox™, Apple's Safari™, or Google's Chrome™ using an Internet-capable communication device such as those described in FIGS. 1-2. The web portal 302 can be configured, for example, to access a media processor 106 and services managed thereby such as a Digital Video Recorder (DVR), a Video on Demand (VoD) catalog, an Electronic Programming Guide (EPG), or a personal catalog (such as personal videos, pictures, audio recordings, etc.) stored at the media processor 106. The web portal 302 can also be used for provisioning IMS services described earlier, provisioning Internet services, provisioning cellular phone services, and so on.

It is contemplated by the subject disclosure that the web portal 302 can further be utilized to manage and provision software applications 162-164, and 172-174 to adapt these applications as may be desired by subscribers and service providers of communication systems 100-200.

FIG. 4 depicts an illustrative embodiment of a communication device 400. Communication device 400 can serve in whole or in part as an illustrative embodiment of the devices depicted in FIGS. 1-2. The communication device 400 can comprise a wireline and/or wireless transceiver 402 (herein transceiver 402), a user interface (UI) 404, a power supply 414, a location receiver 416, a motion sensor 418, an orientation sensor 420, and a controller 406 for managing operations thereof. The transceiver 402 can support short-range or long-range wireless access technologies such as Bluetooth, ZigBee, WiFi, DECT, or cellular communication technologies, just to mention a few. Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 402 can also be adapted to support circuit-switched wireline access technologies (such as PSTN), packet-switched wireline access technologies (such as TCP/IP, VoIP, etc.), and combinations thereof.

The UI 404 can include a depressible or touch-sensitive keypad 408 with a navigation mechanism such as a roller ball, a joystick, a mouse, or a navigation disk for manipulating operations of the communication device 400. The keypad 408 can be an integral part of a housing assembly of the communication device 400 or an independent device operably coupled thereto by a tethered wireline interface (such as a USB cable) or a wireless interface supporting for example Bluetooth. The keypad 408 can represent a numeric keypad commonly used by phones, and/or a QWERTY keypad with alphanumeric keys. The UI 404 can further include a display 410 such as monochrome or color LCD (Liquid Crystal Display), OLED (Organic Light Emitting Diode) or other suitable display technology for conveying images to an end user of the communication device 400. In an embodiment where the display 410 is touch-sensitive, a portion or all of the keypad 408 can be presented by way of the display 410 with navigation features.

The display 410 can use touch screen technology to also serve as a user interface for detecting user input (e.g., touch of a user's finger). As a touch screen display, the communication device 400 can be adapted to present a user interface with graphical user interface (GUI) elements that can be selected by a user with a touch of a finger. The touch screen display 410 can be equipped with capacitive, resistive or other forms of sensing technology to detect how much surface area of a user's finger has been placed on a portion of the touch screen display. This sensing information can be used control the manipulation of the GUI elements.

The UI 404 can also include an audio system 412 that utilizes common audio technology for conveying low volume audio (such as audio heard only in the proximity of a human ear) and high volume audio (such as speakerphone for hands free operation). The audio system 412 can further include a microphone for receiving audible signals of an end user. The audio system 412 can also be used for voice recognition applications. The UI 404 can further include an image sensor 413 such as a charged coupled device (CCD) camera for capturing still or moving images. The UI 404 can further include a depth sensor 415 comprising, for example, and infrared emitter and infrared sensor to detect depth of objects such as a user's arm when stretched out.

The power supply 414 can utilize common power management technologies such as replaceable and rechargeable batteries, supply regulation technologies, and charging system technologies for supplying energy to the components of the communication device 400 to facilitate long-range or short-range portable applications. Alternatively, the charging system can utilize external power sources such as DC power supplied over a physical interface such as a USB port. The location receiver 416 can utilize common location technology such as a global positioning system (GPS) receiver capable of assisted GPS for identifying a location of the communication device 400 based on signals generated by a constellation of GPS satellites, thereby facilitating location services such as navigation. The motion sensor 418 can utilize motion sensing technology such as an accelerometer, a gyroscope, or other suitable motion sensing to detect motion of the communication device 400 in three-dimensional space. The orientation sensor 420 can utilize orientation sensing technology such as a magnetometer to detect the orientation of the communication device 400 (North, South, West, East, combined orientations thereof in degrees, minutes, or other suitable orientation metrics).

The communication device 400 can use the transceiver 402 to also determine a proximity to a cellular, WiFi, Bluetooth, or other wireless access points by common sensing techniques such as utilizing a received signal strength indicator (RSSI) and/or a signal time of arrival (TOA) or time of flight (TOF). The controller 406 can utilize computing technologies such as a microprocessor, a digital signal processor (DSP), and/or a video processor with associated storage memory such as Flash, ROM, RAM, SRAM, DRAM or other storage technologies.

Other components not shown in FIG. 4 are contemplated by the subject disclosure. For instance, the communication device 400 can include a reset button (not shown). The reset button can be used to reset the controller 406 of the communication device 400. In yet another embodiment, the communication device 400 can also include a factory default setting button positioned below a small hole in a housing assembly of the communication device 400 to force the communication device 400 to re-establish factory settings. In this embodiment, a user can use a protruding object such as a pen or paper clip tip to reach into the hole and depress the default setting button.

The communication device 400 as described herein can operate with more or less components described in FIG. 4. These variant embodiments are contemplated by the subject disclosure.

The communication device 400 can be adapted to perform the functions of the media processor 106, the media devices 108, or the portable communication devices 116 of FIG. 1, as well as the IMS CDs 201-202 and PSTN CDs 203-205 of FIG. 2. It will be appreciated that the communication device 400 can also represent other devices that can operate in communication systems 100-200 of FIGS. 1-2 such as a gaming console and a media player.

It is contemplated by the subject disclosure that the communication device 400 shown in FIG. 4 or portions thereof can serve as a representation of one or more of the devices of communication systems 100-200. It is further contemplated that the controller 406 can be adapted in various embodiments to perform the functions 162-166 and 172-176, respectively.

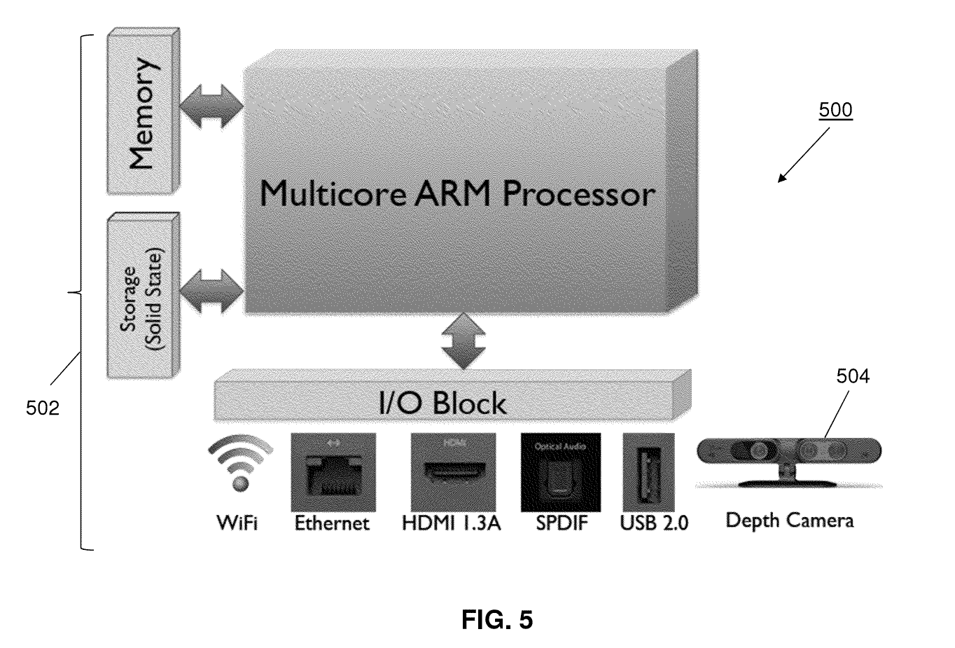

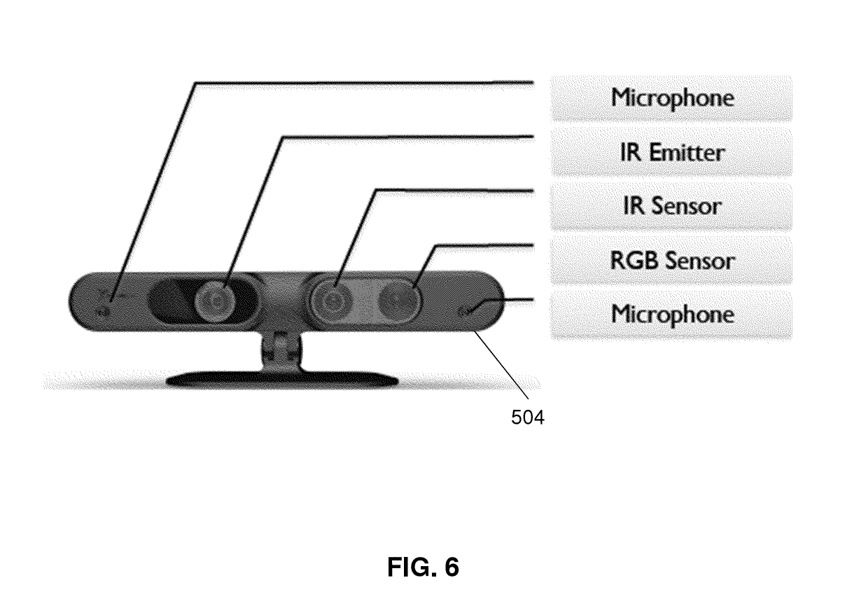

FIGS. 5-6 depict illustrative embodiments of a system 500 for generating a virtual touchscreen. The system 500 illustrated in FIG. 5 can include computing resources 502 including, for example, a multicore ARM processor and memory devices for storing media content and computer instructions which are executed by the ARM processor. The ARM processor can be coupled to input/output blocks supporting various I/O port technologies such as a WiFi port, an Ethernet port, a high-definition multimedia interface (HDMI) port, a Sony/Philips Digital InterFace (SPDIF) port, or a USB 2.0 port for exchanging media signals and controlling a presentation device such as a high-definition television, a portable media player, a computer monitor, and other suitable presentation devices. The computing resources 502 of system 500 can be included in a Depth Camera 504 as shown in FIGS. 5-6. The Depth Camera 504 can further include a pair of microphones for receiving audible signals, an infrared (IR) emitter, an IR sensor, and an image (red, green, blue or RGB) sensor. The Depth Camera 600 can process detectable signals of a user to calibrate a virtual touchscreen, position the virtual touchscreen as the user moves, and sense manipulations of the virtual touchscreen to control functions of a media device.

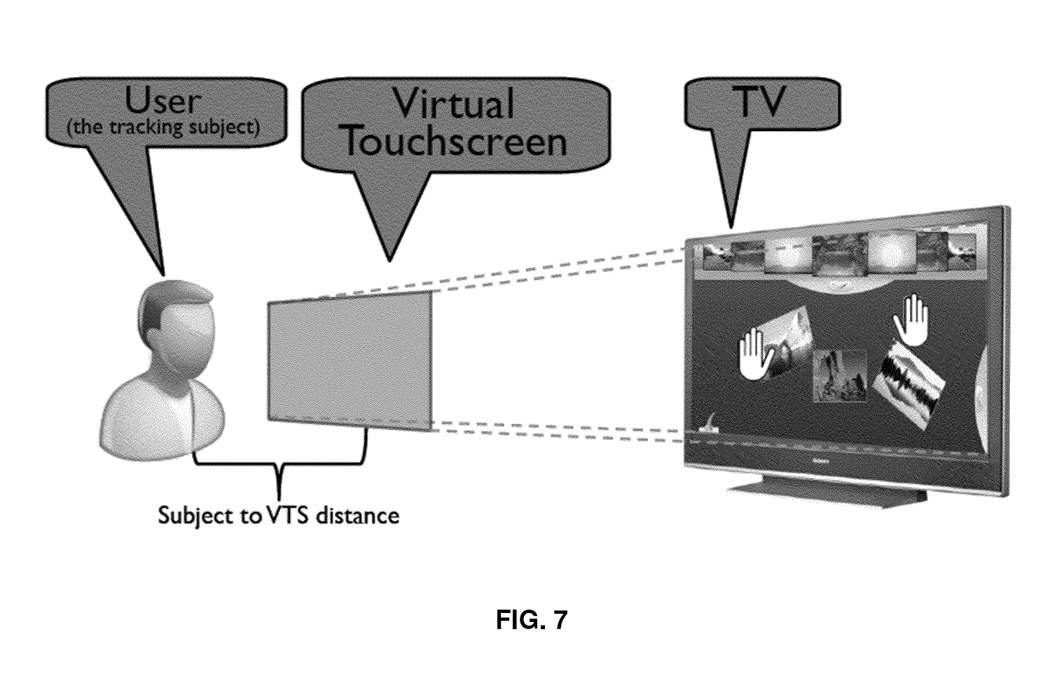

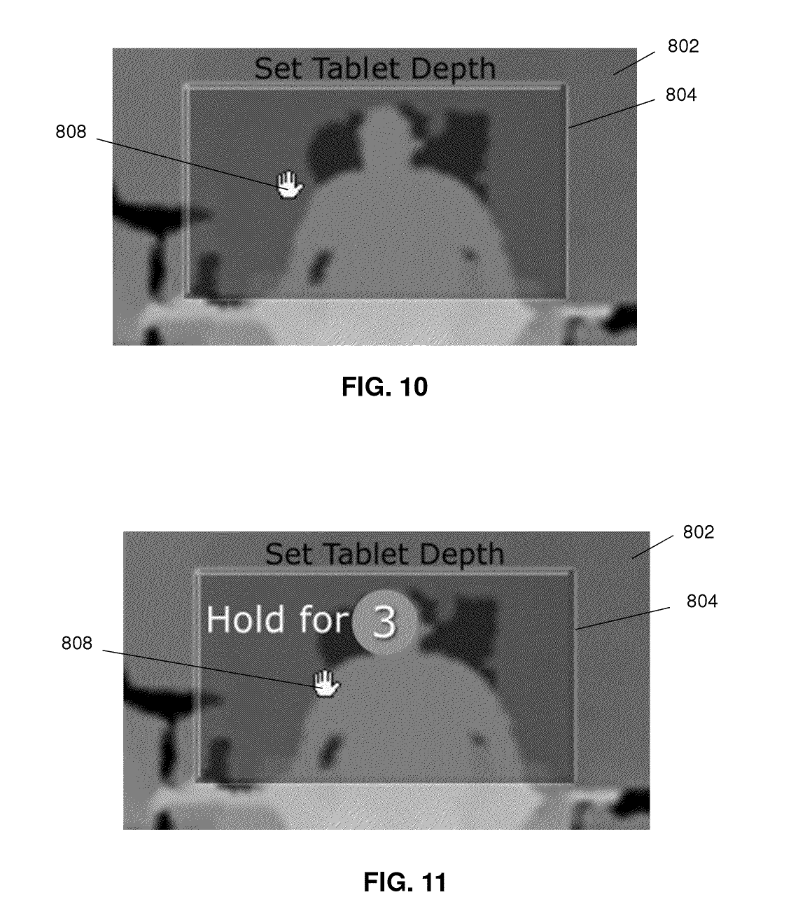

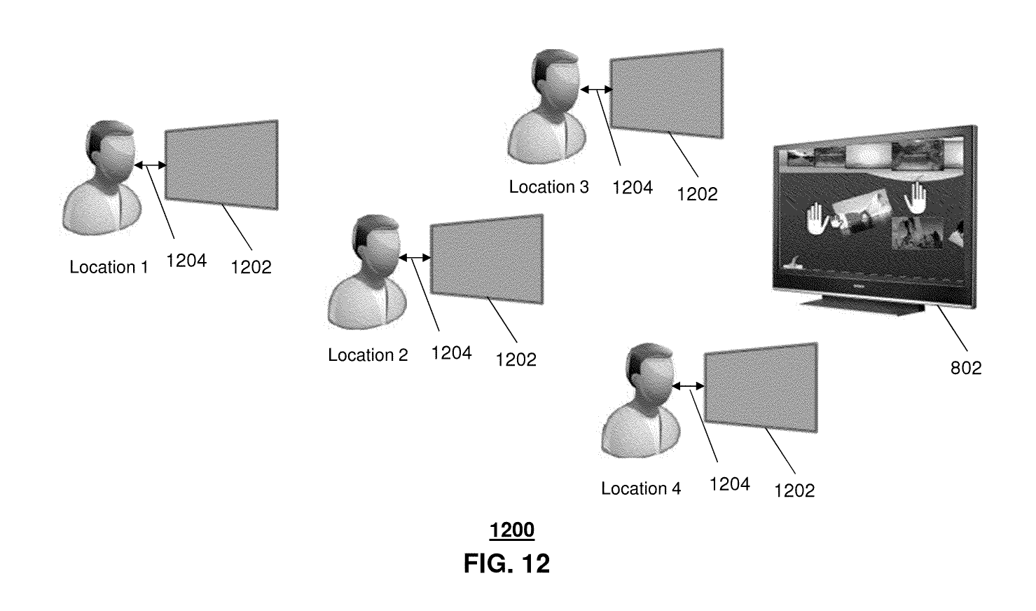

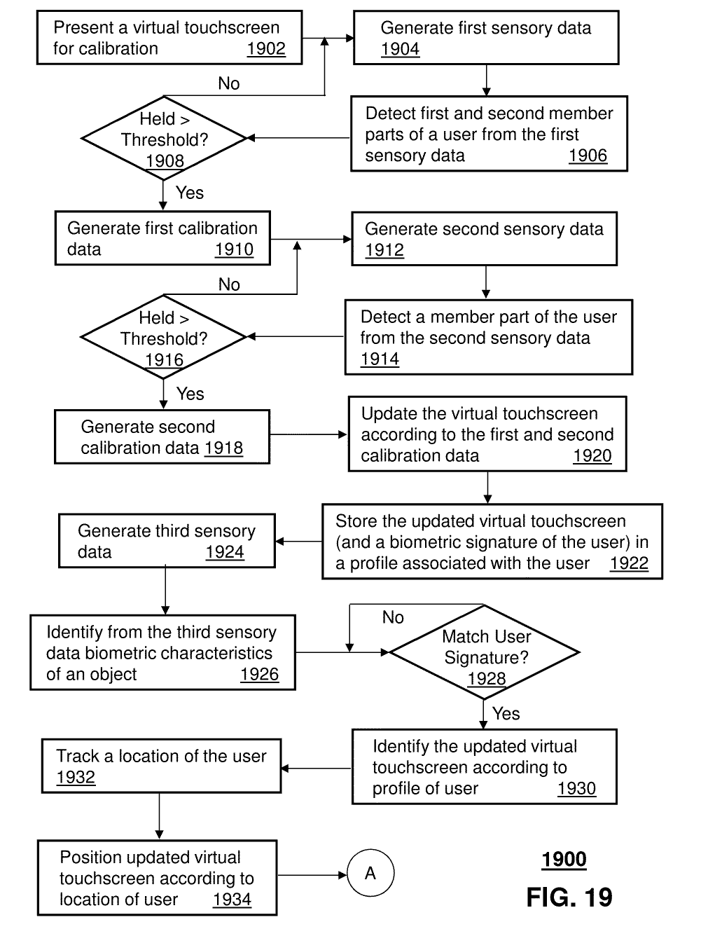

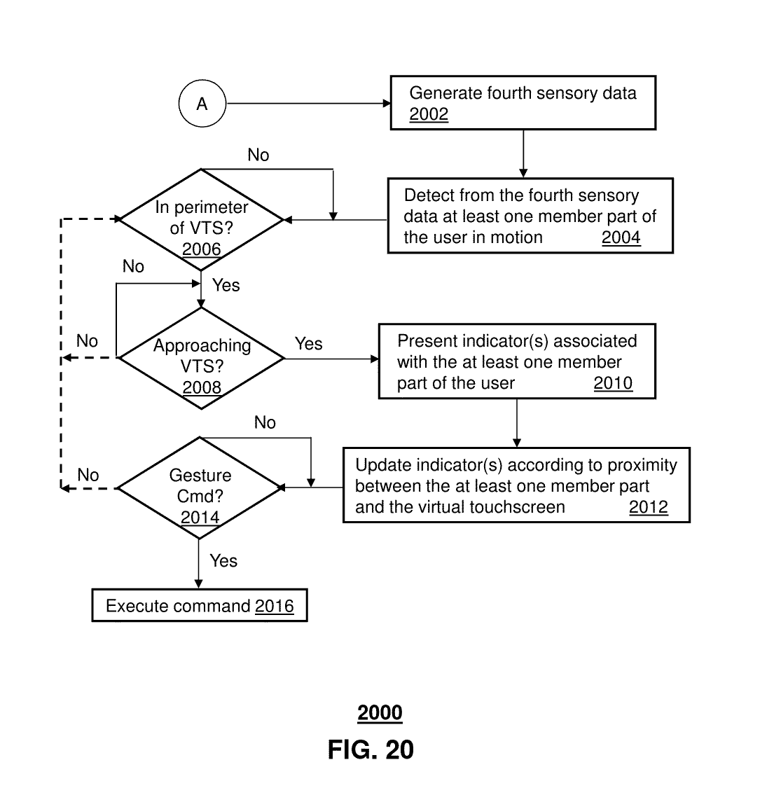

FIGS. 7-11 depict illustrative embodiments for calibrating the virtual touchscreen. FIGS. 12-18 depict illustrative embodiments for controlling the virtual touchscreen. These illustrations are best described by embodiments of methods 1900-2000 depicted in FIGS. 19-20 operating in portions of the systems described in FIGS. 1-6.

Method 1900 can begin with step 1902 in which the system 500 presents a virtual touchscreen for calibration in a configuration as shown in FIG. 7. The virtual touchscreen as referred to in the subject disclosure is “virtual” in that the user cannot see or touch the touchscreen near him or her, but can sense its presence in a vicinity of the user for purposes of controlling a presentation at a presentation device such as a television.

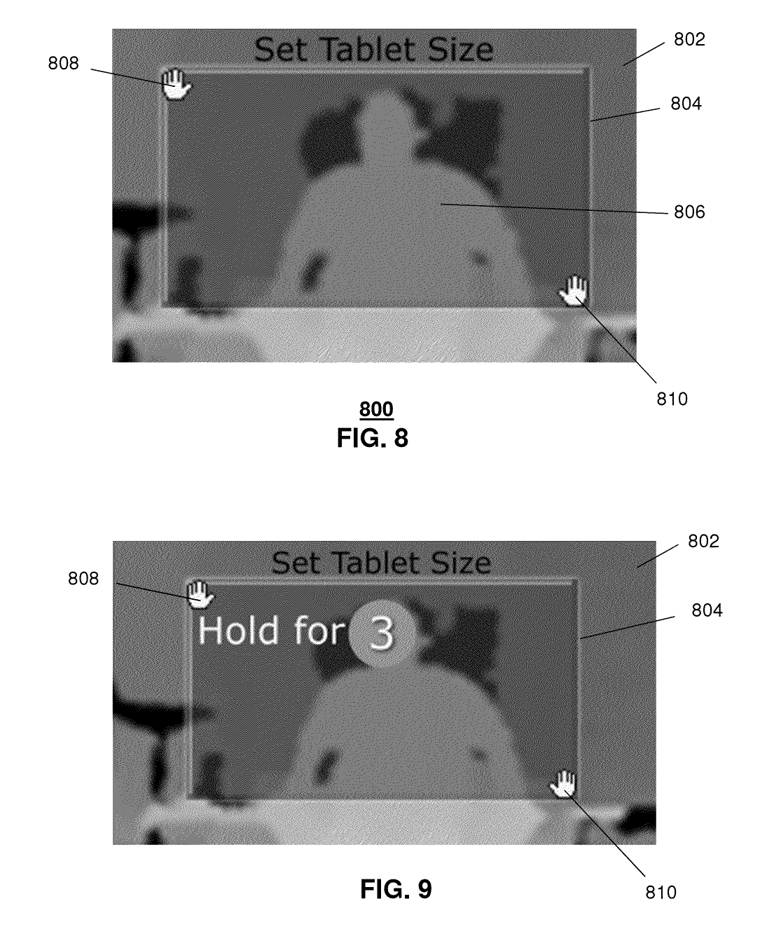

To initiate the calibration process, the system 500 can instruct the user to place his or her hands apart such as shown in FIG. 8 to identify a preferred size of the virtual touchscreen. The system 500 can instruct the user in this regard by presenting an audible message, by presenting a text at the presentation device 802 of FIG. 8, by presenting at the presentation device 802 illustrations of how to place hands, or combinations thereof. In one embodiment, the user can place his or her right hand 808 and left hand 810 at opposite vertices of the virtual touchscreen (“diagonal” or “hypotenuse”) to identify a preferred size of the virtual touchscreen (referred to herein as VTS). To assist the user in envisioning the VTS, the system 500 can present a VTS image 804 at the presentation device 802 that changes size as the user moves his or her right hand 808 and left hand 810. The actual user's hands or a graphical representations of hands (that may be computer generated) can be presented as superimposed images at the vertices of the VTS image 804. To further assist the user during the calibration process, a user image 806 can be presented behind the VTS image 804 enabling the user to visualize the size of the VTS relative to the user. The user image 806 can be received, processed and presented at the presentation device 802 by the system 500 using the RGB image sensor.

While the user is moving his or her right hand 808 and left hand 810 in a diagonal fashion the system 500 can receive first sensory data in step 1904, and in step 1906 detect first and second member parts of the user (e.g., right hand 808 and left hand 810) from the sensory data. The first sensory data can be generated from the RGB sensor. The images included in the sensory data can be processed with image processing technology to detect the user and the location of member parts of the user. The sensory data can also include depth information of the user's hands determined from a combination of IR signals generated by the IR emitter that are reflected back from member parts of the user, and received by the IR sensor. Once the user has determined a desirable size for the VTS image 804, the user can signal the system 500 at step 1908 that desirable dimensions of the VTS image 804 have been established by keeping the user's right hand 808 and left hand 810 in substantially the same position for a predetermined period (e.g., 3 seconds).

Responsive to detecting desirable dimensions for the VTS at step 1908, the system 500 can proceed to step 1910 where it generates first calibration data. The system 500 can then instruct the user to stretch out at least one hand to determine a preferred position of the VTS relative to a body surface of the user (e.g., the user's face). Such instructions can be audible, text, or illustrative presentations generated by the system 500. For illustration purposes, it is assumed the user stretches out his or her right hand 808 as depicted in HG. 10. While the user is stretching out his or her right hand 808, the system 500 is receiving second sensory data at step 1912 and detecting the right hand 808 at step 1914.

The second sensory data can include depth information as well as image information. The depth information can indicate where the user's right hand 808 is relative to a body surface such as the user's face. The image information can indicate to the system 500 where the user has positioned his or her right hand 808 and present an image thereof or representative graphical image of a hand superimposed on the VTS image 804. If the user stretches out his or her right hand 808 and maintains it in substantially the same depth position for a period of time (e.g., 3 seconds) as shown in FIG. 11, the system 500 can detect this state in step 1916 and generate second calibration data in step 1918. The second calibration data can indicate how far the user's hand is stretched out from the user's face.

Once the first and second calibration data has been generated, the system 500 can proceed to step 1920 where it updates the VTS according to this information. The system 500 can, for example, determine from the first calibration data the dimensions of the VTS in two or three dimensional space, and can determine from the second calibration data that the VTS is to be positioned from the user's face at approximately 80% of the distance determined from the user's face to the user's outstretched right hand 808. The system 500 can choose less than 100% in order to allow the user to easily reach the VTS without forcing the user to always stretch out his or hands to their maximum outstretched position.

Once the VTS has been updated, it can be stored by the system 500 in a user profile of the user at step 1922. In one embodiment, the system 500 can also store the updated VTS with a biometric signature of the user to enable the system 500 to automatically detect the user without being prompted by the user. The biometric signature can be an image of the user or biometric analysis of the user such as height, shoulder width, shape of face, facial characteristics, length of arms, length of legs, and so on.

Once calibration is completed, the system 500 can proceed to step 1924 where it generates third sensory data from images and IR reflected signals from objects in its vicinity during day-to-day operation. At step 1926 the system 500 can detect biometric characteristics of a detected object. For example, the system 500 can detect with image processing technology that the object is a biped of a particular height, with other distinguishable member parts (e.g., head, shoulders, arms, etc.). From this information, the system 500 can filter out animals (quadrupeds) and from the features of the member parts identify a signature match in step 1928 with a particular user. Upon such detection, the system 500 can proceed to step 1930 where it retrieves an updated VTS from a user profile of the detected user.

At step 1932 the system 500 can track a location of the user and synchronize at step 1934 the position of the VTS relative to the user as shown in FIG. 12. In these steps, the system 500 can maintain the VTS 1202 at a distance 1204 previously determined according to the second calibration data at any location chosen by the user. In this manner the user can become accustomed to expecting the VTS 1202 to be in the same position, of a certain dimension, and useable at any location desired by the user.

To detect a command from the user, the system 500 can generate fourth sensory data at step 2002 as depicted in FIG. 20. The fourth sensory data can include image and depth information. At step 2004 the system 500 can detect from the sensory data at least one member part of the user in motion (e.g., right hand). The system can further determine if the member part is within a perimeter of the VTS 1202 at step 2006. If, for example, the user is positioning his or her hand outside of the perimeter of the VTS 1202, then the system 500 can assume that the user is not interested in using the VTS 1202 and ignores the instance of the fourth sensory data. If, however, the hand of the user is within the perimeter of the VTS 1202, the system 500 proceeds to step 2008 where it detects whether the user's hand is approaching the VTS 1202 according to depth information detected from reflected IR signals sensed by the IR sensor and/or from image information processed by the system 500.

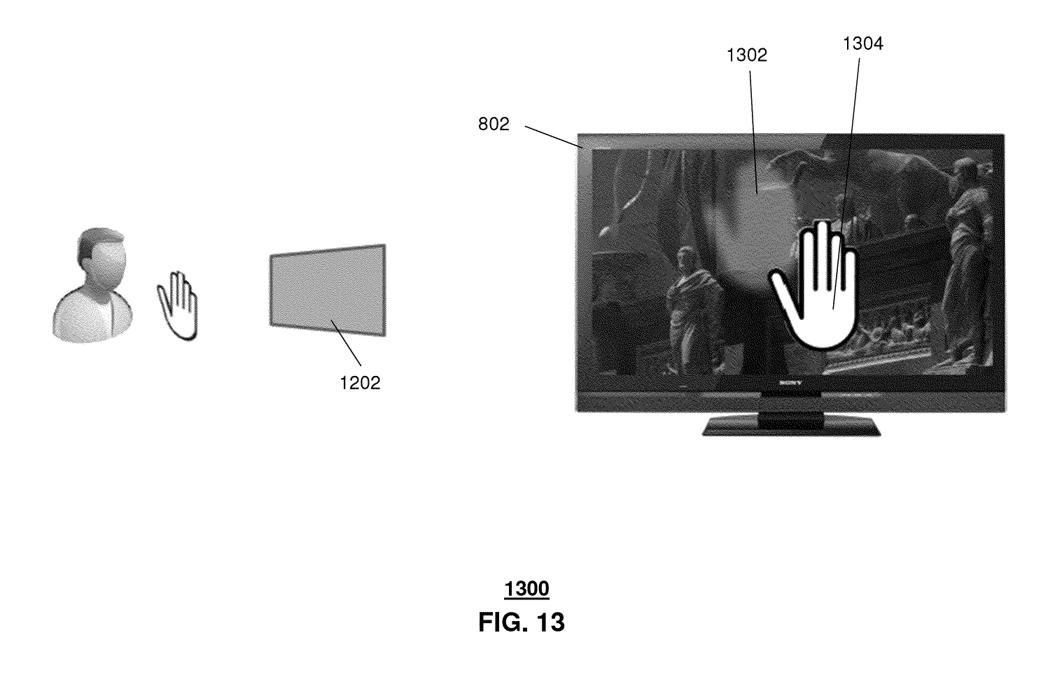

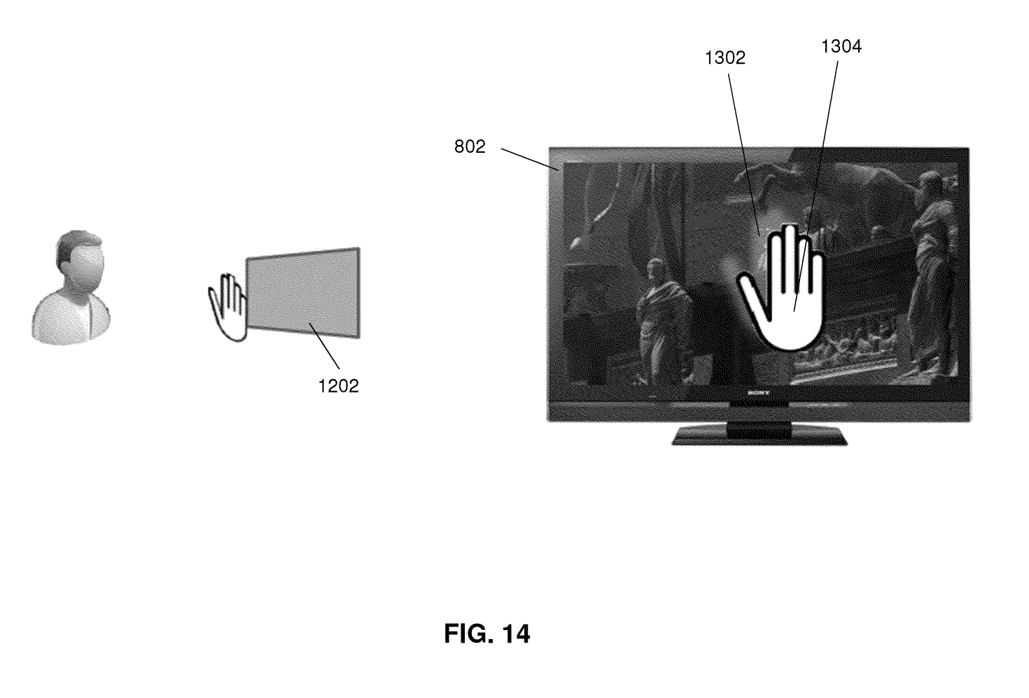

When the member part of the user is within the perimeter of the VTS 1202, the system 500 can assist the user in detecting this event by presenting an actual or graphical representation of the member part superimposed on the presentation device 802 as shown in FIGS. 13-18. Assuming the member part is the user's hand, the system 500 can present at the presentation device 802 one or more indicators at step 2010 that can change in presentation at step 2012 to further assist the user in determining how close the user's hand is to the VTS 1202. In one embodiment, the system 500 can present a shadow 1302 of the user's hand and an actual or representative graphical image of the hand 1304 at the presentation device 802 as shown in FIG. 13. When the user's hand is not close to the VTS 1202, the representative hand 1304 is kept away from the shadow 1302 as shown in FIG. 13. As the user's hand gets much closer to the VTS 1202, the shadow 1302 and the representative hand 1304 converge as shown in FIG. 14 much like shadows in real-life depict a similar behavior.

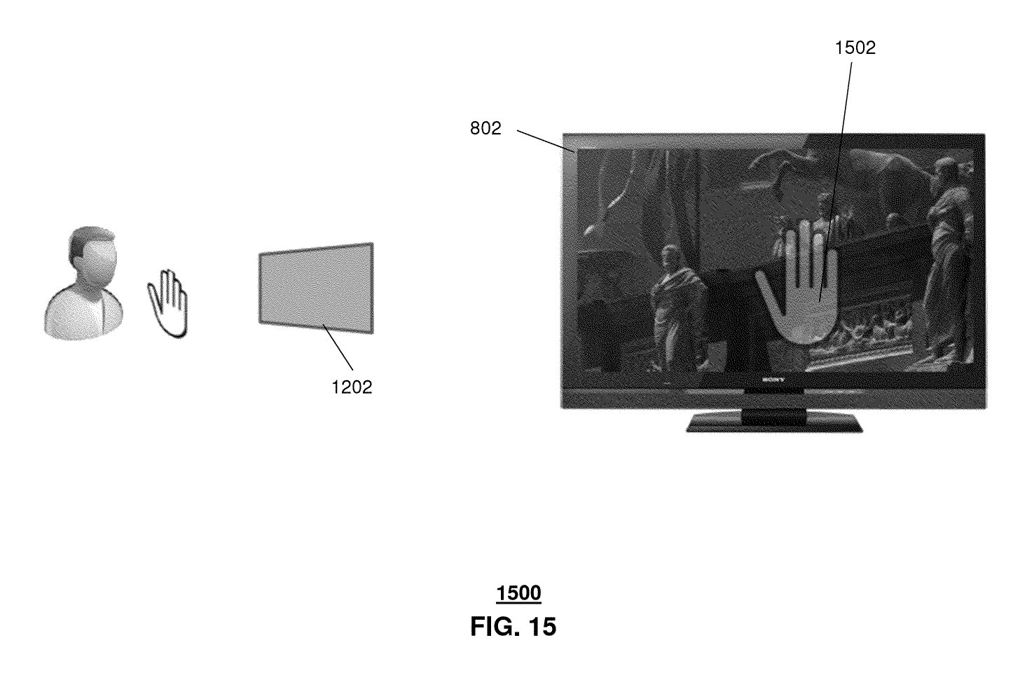

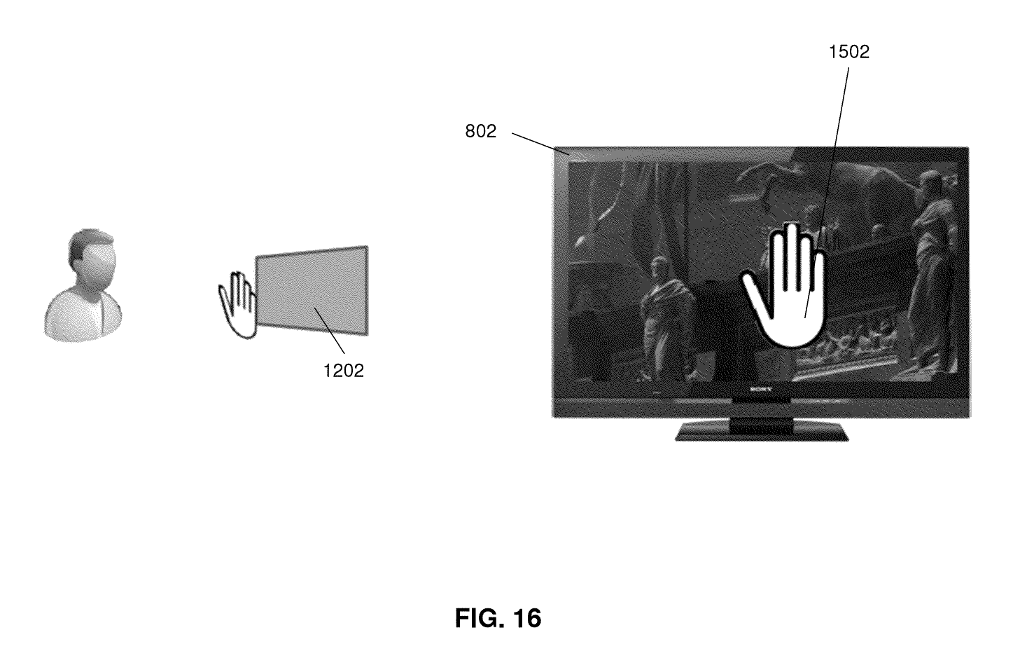

In another embodiment, the system 500 can depict a member part in proximity to the VTS 1202 by varying the illumination of a representative hand 1502 as shown in FIG. 15. When the user's hand is in the perimeter of the VTS 1202, but at a distance from the VTS 1202, the system 500 depicts the representative hand 1502 as a semi-transparent hand. When the user's hand moves in close proximity to the VTS 1202, the representative hand 1502 becomes less transparent and more opaque as shown in FIG. 16.

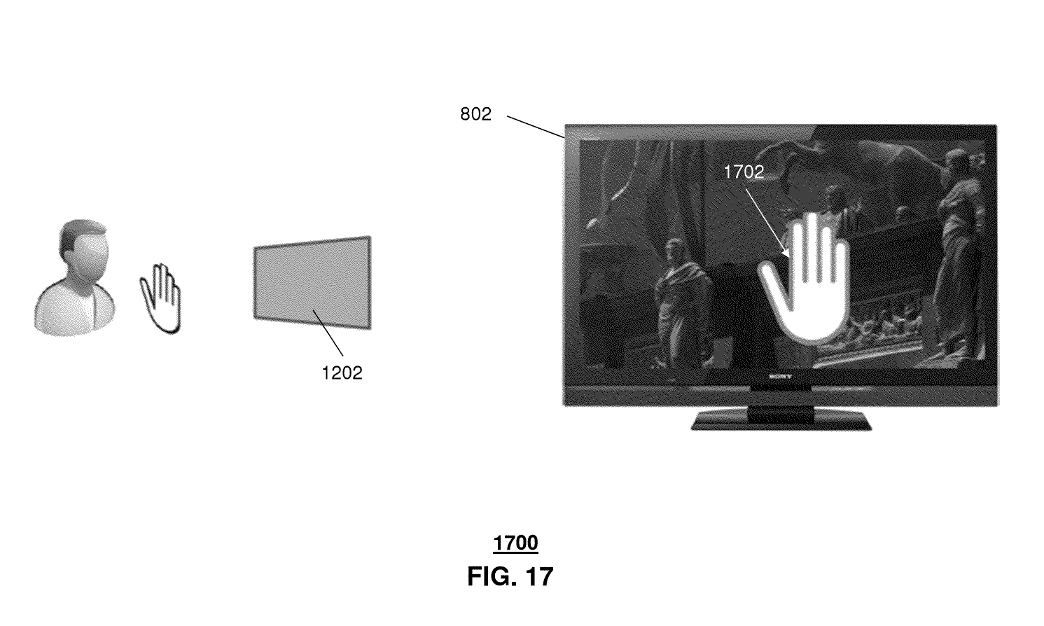

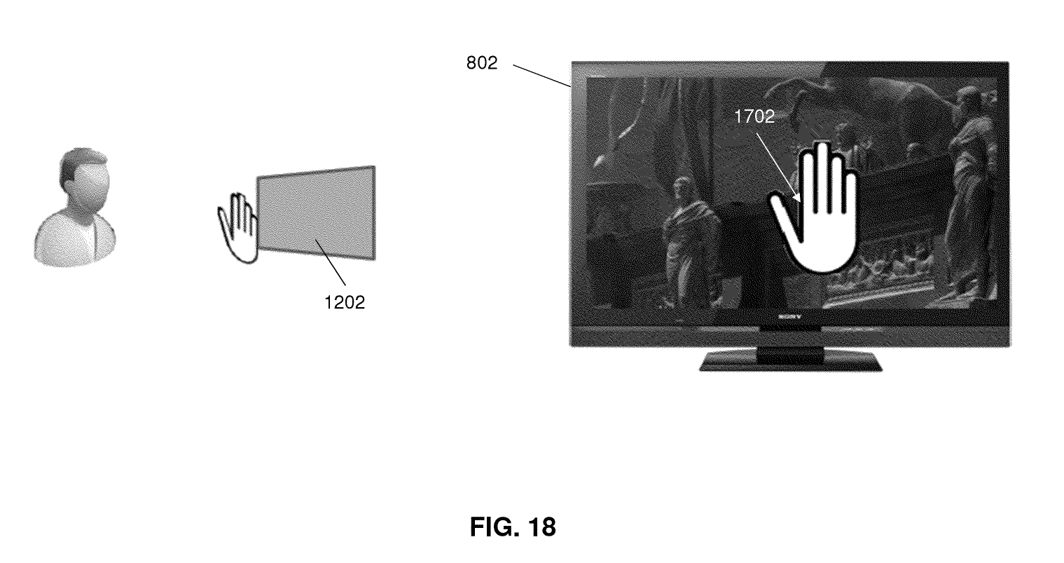

In yet another embodiment, the system 500 can depict proximity of a user's hand to the VTS 1202 by changing a color of an outer perimeter of the representative hand 1702 as shown in FIG. 17 to another color as the user's hand reaches close proximity to the VTS 1202 as shown in FIG. 18. Other suitable modes for presenting the proximity of a member part of a user to the VTS 1202 are contemplated by the subject disclosure.

Once the user's hand is in close proximity to the VTS 1202, the system 500 can detect commands at step 2014 by comparing the movement of the member parts in the VTS 1202 to a gesture library. If a gesture command is detected at step 2014 (e.g., zoom-in command detected from a gesture in which the user's hands are detected in close proximity to each other and then expand outwardly, a zoom-out command from a reverse gesture, etc.), the system 500 proceeds to step 2016 where it executes the requested command.

The aforementioned embodiments of methods 1900-2000 create a predictable and repeatable approach for creating a virtual touchscreen for users independent of their location.

Upon reviewing the aforementioned embodiments, it would be evident to an artisan with ordinary skill in the art that said embodiments can be modified, reduced, or enhanced without departing from the scope and spirit of the claims described below. For example, the VTS 1202 created in step 1920 of FIG. 19 can be three dimensional. In another embodiment, method 1900 can be adapted whereby the profile stores the first and second calibration data and the VTS 1202 is created therefrom when invoked by the user or by biometric detection of the user. Method 2000 can be adapted to also accept speech commands which can be combined with gesture commands. In yet another embodiment, portions of methods 1900-2000 can be performed in a distributed computing environment. For example, a portion of the steps of methods 1900 and 2000 can be performed by the server 130, or the application servers 217 in cooperation with the system 500. In another embodiment, system 500 can be an integral part of a housing assembly of the media processor 106, the media devices 108, or the wireless communication devices 116 of FIG. 1, or the CDs 201, 202, 203 or 205 of FIG. 2. In one embodiment, the system 500 can be programmed, controlled, and provisioned by the portal 302 of FIG. 3.

In yet another embodiment, method 1900 can be adapted to create a default virtual touchscreen based on an analysis of a user's body configuration, arm length, and so on without requesting actions by the user. In this embodiment, sensory data derived from images, infrared information, depth information, or combinations thereof, derived from monitoring the user can be used to generate a default touchscreen having dimensions and a depth from the user's reach that may be desirable to the user. The user can be presented with the default virtual touchscreen by way of a display device with imagery of the user to assist the user in locating the default virtual touchscreen. The steps described in method 2000 can be used to enable the user to determine where hand placements are made relative to the default virtual touchscreen. The user can experiment with the default virtual touchscreen by utilizing it as one would after a calibration to determine if its dimensions and depth are desirable to the user. If the user determines that the default virtual touchscreen is not desirable, the user can signal a processor (e.g., a set-top box or gaming console) presenting the default virtual touchscreen by voice, or hand gesture, that the user wishes to calibrate the default virtual touchscreen to another desirable dimension, and/or depth position relative to the user. Upon receiving such a command, the processor can present the calibration process as described above utilizing the default virtual touchscreen as a starting point.

In another embodiment, methods 1900-2000 can be adapted to operate in a three-dimensional (3D) environment where the virtual touchscreen is visible to the user. For example, a user can utilize polarized or shutter glasses to view images from a presentation device capable of presenting 3D images. A processor controlling the presentation device can be adapted to cause a 3D presentation of the virtual touchscreen near the user. As the user moves from one location to another, the processor can track the user's location and cause the presentation device to present a new 3D representation of the virtual touchscreen much like the illustrations of FIG. 12. The calibration process as described in method 1900 can be adapted to be performed as 3D image representations of the virtual touchscreen.

Other embodiments are contemplated by the subject disclosure.

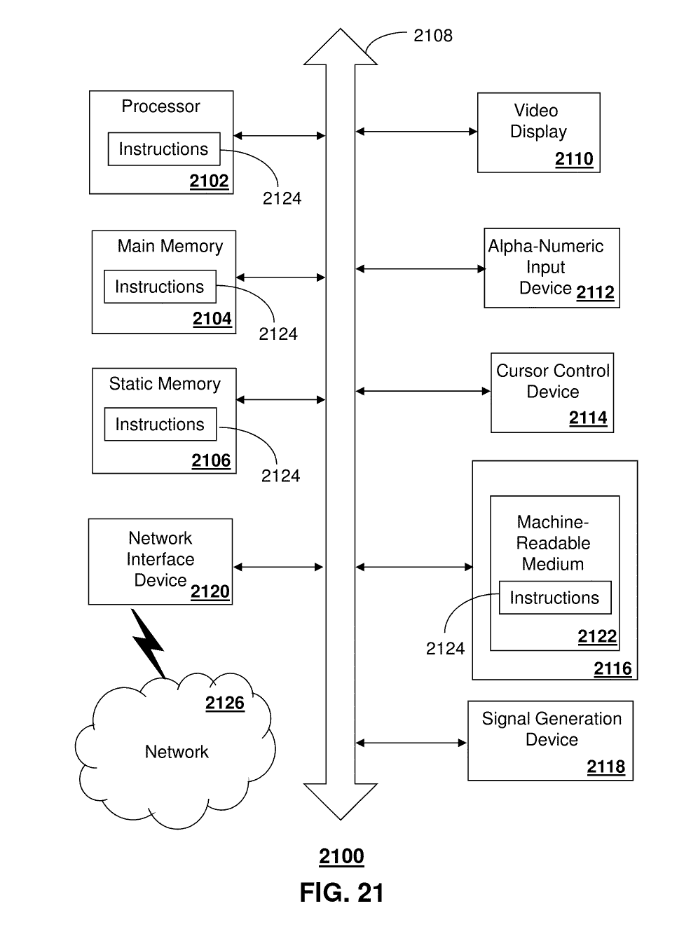

FIG. 21 depicts an exemplary diagrammatic representation of a machine in the form of a computer system 2100 within which a set of instructions, when executed, may cause the machine to perform any one or more of the methods discussed above. One or more instances of the machine can operate, for example, as the server 130, media processor 106 , the media devices 108, the wireless communication devices 116, the CDs 201, 202, 203 or 205, and/or other devices of FIGS. 1-6. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment.

The machine may comprise a server computer, a client user computer, a personal computer (PC), a tablet PC, a smart phone, a laptop computer, a desktop computer, a control system, a network router, switch or bridge, or any machine capable of executing a set of instructions (sequential or otherwise) that specify actions to be taken by that machine. It will be understood that a communication device of the subject disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methods discussed herein.

The computer system 2100 may include a processor 2102 (e.g., a central processing unit (CPU), a graphics processing unit (GPU, or both), a main memory 2104 and a static memory 2106, which communicate with each other via a bus 2108. The computer system 2100 may further include a video display unit 2110 (e.g., a liquid crystal display (LCD), a flat panel, or a solid state display. The computer system 2100 may include an input device 2112 (e.g., a keyboard), a cursor control device 2114 (e.g., a mouse), a disk drive unit 2116, a signal generation device 2118 (e.g., a speaker or remote control) and a network interface device 2120.

The disk drive unit 2116 may include a tangible computer-readable storage medium 2122 on which is stored one or more sets of instructions (e.g., software 2124) embodying any one or more of the methods or functions described herein, including those methods illustrated above. The instructions 2124 may also reside, completely or at least partially, within the main memory 2104, the static memory 2106, and/or within the processor 2102 during execution thereof by the computer system 2100. The main memory 2104 and the processor 2102 also may constitute tangible computer-readable storage media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the subject disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

While the tangible computer-readable storage medium 2122 is shown in an example embodiment to be a single medium, the term “tangible computer-readable storage medium” should be taken to include a single medium or multiple media (e.g., a centralized or distributed database, and/or associated caches and servers) that store the one or more sets of instructions. The term “tangible computer-readable storage medium” shall also be taken to include any non-transitory medium that is capable of storing or encoding a set of instructions for execution by the machine and that cause the machine to perform any one or more of the methods of the subject disclosure.

The term “tangible computer-readable storage medium” shall accordingly be taken to include, but not be limited to: solid-state memories such as a memory card or other package that houses one or more read-only (non-volatile) memories, random access memories, or other re-writable (volatile) memories, a magneto-optical or optical medium such as a disk or tape, or other tangible media which can be used to store information. Accordingly, the disclosure is considered to include any one or more of a tangible computer-readable storage medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are from time-to-time superseded by faster or more efficient equivalents having essentially the same functions. Wireless standards for device detection (e.g., RFID), short-range communications (e.g., Bluetooth, WiFi, Zigbee), and long-range communications (e.g., WiMAX, GSM, CDMA, LTE) are contemplated for use by computer system 2100.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized Accordingly, the specification and drawings are to be regarded in an illustrative rather than a restrictive sense.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, are contemplated by the subject disclosure.

The Abstract of the Disclosure is provided with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A device, comprising:
a memory storing computer instructions; and
a processor coupled to the memory, wherein the processor responsive to executing the computer instructions performs operations comprising:
presenting a virtual touchscreen at a presentation device;
receiving from a sensor a plurality of signals comprising image information and depth information associated with member parts of a user;
generating first calibration data from the plurality of signals to identify a plurality of dimensions of the virtual touchscreen; and
generating second calibration data from the plurality of signals to identify an operating distance between the user and the virtual touchscreen.

2. The device of claim 1, wherein the sensor comprises one of an imaging sensor, a depth sensor, or both.

3. The device of claim 1, wherein the image information depicts first and second member parts of the user to identify first and second positions on the virtual touchscreen.

4. The device of claim 1, wherein the processor responsive to executing the computer instructions performs operations comprising:
determining from one of the image information, the depth information, or both a relative position of first and second member parts of the user;
generating the first calibration data according to the relative position to identify the plurality of dimensions of the virtual touchscreen; and
reconfigure the virtual touchscreen according to the plurality of dimensions.

5. The device of claim 4, wherein the processor responsive to executing the computer instructions performs operations comprising:
detecting that the first and second member parts are substantially held in the relative position for a period of time exceeding a threshold; and
generating the first calibration data responsive to the detection.

6. The device of claim 1, wherein the processor responsive to executing the computer instructions performs operations comprising presenting at the presentation device an image of the user in combination with the virtual touchscreen.

7. The device of claim 1, wherein the processor responsive to executing the computer instructions performs operations comprising:
processing the plurality of signals to determine dimensional characteristics of the member parts of the user;
generating a default virtual touchscreen according to the dimensional characteristics of the member parts of the user; and
presenting the default virtual touchscreen at the presentation device to initiate a calibration process.

8. The device of claim 1, wherein the processor responsive to executing the computer instructions performs operations comprising:
determining from one of the image information, the depth information, or both a relative position of a first member part and a body surface of the user; and
generating the second calibration data according to the relative position to identify the operating distance between the user and the virtual touchscreen; and
repositioning the virtual touchscreen according to a detected location of the user and the operating distance.

9. The device of claim 8, wherein the processor responsive to executing the computer instructions performs operations comprising:
detecting that the first member part is substantially held in the relative position for a period of time exceeding a threshold; and
generating the second calibration data responsive to the detection.

10. The device of claim 1, wherein the processor responsive to executing the computer instructions performs operations comprising:
updating the virtual touchscreen according to the first calibration data and the second calibration data to generate an updated virtual touchscreen;
tracking a location of the user; and
synchronizing the updated virtual touchscreen with the tracked location of the user.

11. The device of claim 10, wherein the processor responsive to executing the computer instructions performs operations comprising:
receiving from the sensor a second plurality of signals associated with the user;
detecting from the second plurality of signals a member part of the user in motion; and
presenting at the presentation device an indicator of the member part only when the member part approaches the updated virtual touchscreen within a perimeter of the updated virtual touchscreen.

12. The device of claim 11, wherein the processor responsive to executing the computer instructions performs operations comprising:
determining a relative position between the member part and the updated touchscreen; and
updating the indicator according to the relative position to signify a measure of proximity to the updated touchscreen.

13. The device of claim 12, wherein updating the indicator is achieved according to one of presenting a shadow of the indicator converging with the indicator as the member part approaches the updated touchscreen, changing the transparency of at least a portion of the indicator as the member part approaches the updated touchscreen, changing a color of at least a portion of the indicator as the member part approaches the updated touchscreen, or combinations thereof.

14. The device of claim 11, wherein the indicator comprises one of an image of the member part, or a graphical representation of the member part.

15. The device of claim 11, wherein the processor responsive to executing the computer instructions performs operations comprising:
detecting a command caused by a movement of the member part; and
causing an update of a presentation at the presentation device according to the detected command.

16. The device of claim 1, wherein the processor responsive to executing the computer instructions performs operations comprising:
storing the first and the second calibration data in a profile associated with the user;
receiving from the sensor a plurality of signals;
identifying from the second plurality of signals biometric characteristics of an object;
detecting that the biometric characteristics of the object substantially match a biometric signature of the user; and
associating a customized virtual touchscreen configured according to the first and second calibration data and a location of the user responsive to detecting the substantial match between the biometric characteristics of the object and the biometric signature of the user.

17. A computer-readable storage medium, comprising computer instructions, which when executed by at least one processor causes the at least one processor to perform operations comprising:
generating first calibration data from a plurality of signals to identify a plurality of dimensions of a virtual touchscreen;
generating second calibration data from the plurality of signals to identify an operating distance between the user and the virtual touchscreen;
generating an updated virtual touchscreen according to the first and second calibration data;
tracking a location of the user; and
positioning the updated virtual touchscreen according to the location of the user.

18. The computer-readable storage medium of claim 17, wherein generating the updated virtual touchscreen includes operations comprising:
resizing the virtual touchscreen according to the plurality of dimensions; and
repositioning the virtual touchscreen according to the operating distance.

19. A method, comprising:
generating, by a system comprising at least one processor, a virtual touchscreen according to a first relative position between a plurality of member parts of a user and according to a second relative position of at least one member part of the user and a body surface of the user;
tracking, by the system, a location of the user; and
positioning, by the system, the virtual touchscreen according to the location of the user.

20. The method of claim 19, comprising:
determining, by the system, from the first relative position a plurality of dimensions of the virtual touchscreen;
determining, by the system, from the second relative position an operating distance between the user and the virtual touchscreen;
resizing, by the system, the virtual touchscreen according to the plurality of dimensions; and
repositioning, by the system, the virtual touchscreen from the user according to the operating distance.
